(19) United States
(12) Patent Application Publication
(10) Pub. No.: US 2008/0288149 A1
(43) Pub. Date: Nov. 20, 2008

(54) Method And System For Regulating Vehicle Dynamics

(76) Inventor: Edo Drenth, Helsingborg (SE)

Correspondence Address: ST. ONGE STEWARD JOHNSTON & REENS, LLC, 986 BEDFORD STREET, STAMFORD, CT, 06905-5619, US

(21) Appl. No.: 12/131,467

(22) Filed: Jun. 2, 2008

Related U.S. Application Data
(63) Continuation of application No. PCT/EP2005/056434, filed on Dec. 2, 2005.

(51) Int. Cl. G06F 19/00; B60W 10/04; G06F 17/30

(52) U.S. Cl. 701/70; 477/175; 707/201

(57) ABSTRACT

A method of regulating the driving dynamics of a vehicle by controlling a torque distribution from a vehicle engine between at least two axles of the vehicle is disclosed. The method comprises controlling the torque distribution with a nominal velocity difference between the different axles as an input value. According to an embodiment, the sign of the velocity difference between both outgoing shafts from the double coupling device is used to determine a control state of the double coupling.

### CROSS-REFERENCE TO RELATED APPLICATIONS

The present application is a continuation of pending International patent application PCT/EP2005/056434 filed on Dec. 2, 2005 which designates the United States, the content of which is incorporated herein by reference.

### FIELD OF THE INVENTION

This invention pertains in general to the field of vehicle dynamics. More particularly the invention relates to regulating the driving dynamics of a vehicle, and even more particularly to a method of regulating the driving dynamics of a vehicle by controlling a torque distribution from a vehicle engine between at least two axles of the vehicle.

### BACKGROUND OF THE INVENTION

Torque distributors for vehicles are known as a piece of hardware, e.g. for four wheel drive vehicles, that is placed between the gearbox output and the both propelled axles of a two-axled vehicle. This hardware ensures that the total torque capacity between the gearbox output and both axles is always larger than the maximum torque output from the gearbox. Simultaneously, the torque between front and rear axle can be varied freely while maintaining always one clutch locked or in a so-called synchronous state. The exception is when the double clutch device is used as a declutch mechanism for gear shifting as well.

For instance WO 2005/035294 discloses such a hardware. More precisely, a drive train and a method for controlling and regulating the drive train of a vehicle are disclosed in WO 2005/035294. A gear-box is interposed between a vehicle engine and two vehicle axles. One controlled and regulated clutch each is provided between the gear-box and the vehicle axles, wherein the transmissibility of the regulated clutches can be adjusted via an actuator system. In this way a driving torque is distributed between the vehicle axles depending on the adjusted torque transmissibility of the two clutches. The transmissibilities of the clutches can be adjusted by means of the actuator system in such a manner that a clutch can be operated in a slip mode while the other clutch can be maintained in a generally synchronous state, thereby distributing the driving torque between the axles. The disclosure mentions only a mechanical arrangement that may be used for distributing the torque between the axles. Those skilled in the art understand that the torque distribution between the axles influences the driving dynamics of a vehicle. It is not disclosed how this distribution may be controlled in an efficient way in order to provide advantageous characteristics of the vehicles' driving dynamics.

Thus, there is a need for a method of regulating the driving dynamics of a vehicle by controlling a torque distribution from a vehicle engine between at least two axles of the vehicle, for instance by controlling a torque distribution controller as disclosed in WO 2005/035294.

WO 2005/073011 discloses a method for controlling a motor vehicle torque transmitting clutch whose coupling state determines the distribution ratio of a drive torque between a first and a second wheel arrangement of the vehicle. At least one operating parameter of the vehicle different from a velocity of the vehicle is monitored with regard to a predetermined condition, which is representative of an acceleration process that is initiated by a vehicle driver and results in an increased vehicle speed. When an acceleration process is recognized, the clutch is placed in a fixed predetermined acceleration coupling state. The engine torque, which is provided by a driving engine of the vehicle, and/or the position of an accelerator pedal of the vehicle are/is preferably used as a representative operating parameter for recognizing an acceleration process. However, the method disclosed in WO 2005/073011 only takes into consideration that a longitudinal acceleration takes place and is hence very limited from a vehicle dynamics control perspective, as for instance cornering or deceleration conditions are not considered at all.

U.S. Pat. No. 4,966,249 discloses an active torque distribution control over four wheels of a motor vehicle. A longitudinal acceleration and a side acceleration which the vehicle is subject to are detected by means of two acceleration sensors. Based on these longitudinal and side accelerations measured by the sensors, a running mode which the vehicle is involved in is detected, and a torque distribution ratio of a portion of torque delivered to the front wheels to the remaining portion to the rear wheels and a differential limiting force is varied in response to a predetermined control schedule for the running mode detected. However, the system disclosed needs acceleration sensors as mentioned-above, which is a major disadvantage as any-additional piece of equipment, i.e. the acceleration sensors only used for the vehicle dynamics, are prone to errors and expensive. Furthermore the disclosure of U.S. Pat. No. 4,966,249 deals with a single clutch device, limiting the vehicle dynamics control for distributing the drive torque.

Hence, an improved method of regulating the driving dynamics of a vehicle by controlling a torque distribution from a vehicle engine between at least two axles of the vehicle would be advantageous, and in particular allowing for increased flexibility and cost-effectiveness would be advantageous.

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a method, a signal, a computer-readable medium, and a system, for regulating the driving dynamics of a vehicle by controlling a torque distribution from a vehicle engine between at least two axles of the vehicle, according to the appended patent claims.

This invention allows for an overall control of a torque distribution controller within a vehicle dynamics perspective.

According to one aspect of the invention, a method for regulating the driving dynamics by controlling a torque distribution from a vehicle engine between at least two axles of the vehicle of a vehicle is provided, wherein the method comprises controlling the torque distribution with a nominal velocity difference between the different axles as an input value.

According to another aspect of the invention, a system for regulating the driving dynamics of a vehicle is provided. The system is adapted to control a torque distribution from a vehicle engine between at least two axles of the vehicle. The system comprises means for controlling said torque distribution with a nominal velocity difference between the different axles as an input value.

According to a further aspect of the invention, a computer-readable medium having embodied thereon a computer program for regulating the driving dynamics of a vehicle for processing by a computer is provided. The computer program comprises a code segment for a computer-readable medium having embodied thereon a computer program for regulating the driving dynamics of a vehicle for processing by a computer, wherein the computer program is configured to control a torque distribution from a vehicle engine between at least two axles of the vehicle. The computer program comprises a code segment for controlling the torque distribution with a nominal velocity difference between the different axles as an input value.

According to yet a further aspect of the invention an input signal for regulating the driving dynamics of a vehicle is provided. The signal is an input signal for regulating the driving dynamics of a vehicle in a system that is adapted to control a torque distribution from a vehicle engine between at least two axles of the vehicle. The signal comprises information for controlling the torque distribution derived from a nominal velocity difference between the different axles, wherein the signal is an input value used for regulating the driving dynamics of the vehicle.

The present invention has the advantage over the prior art that it provides an advantageous way of regulating the driving dynamics of a vehicle. More precisely some embodiments of the invention allow for avoiding traction problems of vehicles.

### BRIEF DESCRIPTION OF THE DRAWINGS

These and other aspects, features and advantages of which the invention is capable of will be apparent and elucidated from the following description of an embodiment of the present invention, reference being made to the accompanying drawings, in which

FIG. 1 is a schematic overview of velocity vectors at tire contact points in an ISO coordinate system, and

FIG. 2 is a schematic view of an exemplary drive train for implementing the present invention.

### DETAILED DESCRIPTION OF THE INVENTION

The following description focuses on an embodiment of the present invention applicable to a two-axled, four wheel drive car. However, it will be appreciated that the invention is not limited to this application but may be applied to many other vehicles, including for example trucks. In addition such vehicles may have more than two axles.

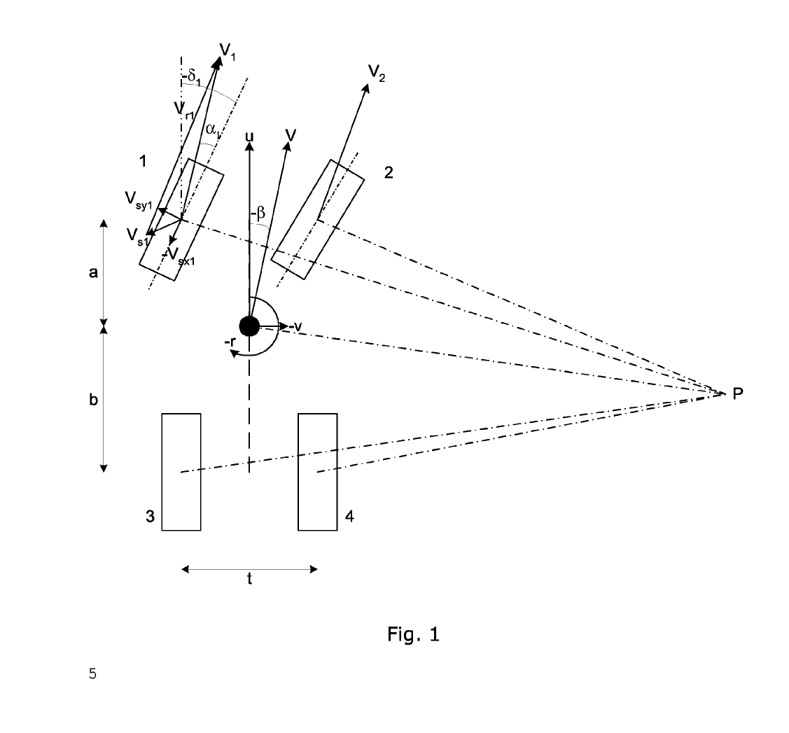

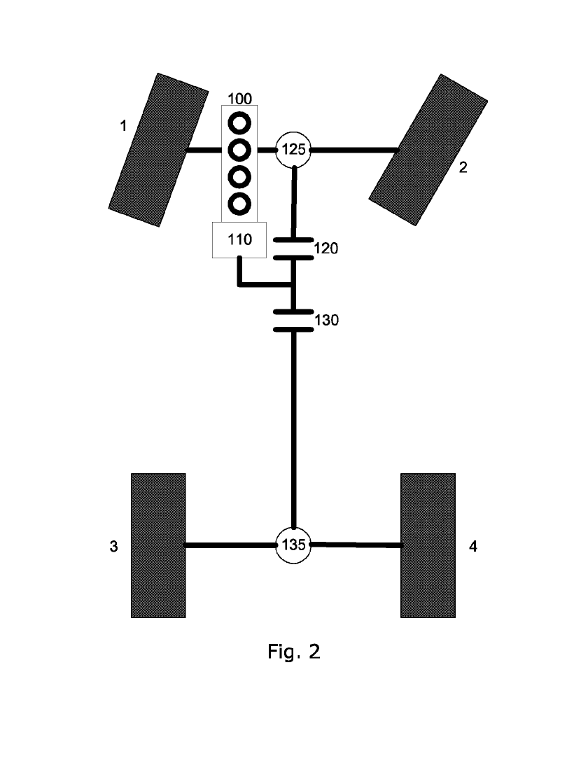

FIG. 2 is a schematic view of an exemplary drive train for implementing the present invention. In the figure, a two-axled all wheel driven vehicle is schematically depicted. The vehicle has a front left wheel 1, a front right wheel 2, a rear left wheel 3, and a rear right wheel 4. Torque from an engine 100 is transmitted to a gearbox 110 and further to a torque distributor placed between the gearbox 110 output and both the propelled axles of the two-axled vehicle. The drive train further comprises a first clutch 120 between gearbox and front axle and a second clutch 130 between gearbox and rear axle. This hardware ensures that the total torque capacity between the gearbox output and both axles is always larger than the maximum torque output from the gearbox. Simultaneously, the torque between front and rear axle may be varied freely while maintaining always one clutch locked or in a so-called synchronous state. An exception is when the double clutch device is used as a declutch mechanism for gear shifting as well. Further, the drive train comprises a front differential 125 and a rear differential 135. FIG. 1, explained below, is a schematic overview of velocity vectors of a vehicle having such a drive train, using the same reference signs, where appropriate.

Torque distribution systems, such as shown in FIG. 2 or the above-mentioned double coupling disclosed in WO 2005035294-A1, can if circumstances allow, freely vary the torque distribution between front and rear axle. However, the vehicle's state may not always allow a transition from one state of the double coupling to another because the actual axle velocity difference induced by the vehicle's state is too large at the time and state transition may imply Noise, Vibrations and Harshness (NVH) problems. State of double coupling means in this context that the front or the rear axle is synchronously connected to the gearbox output by locking one of the two couplings and the torque transmission of the other coupling is controlled by slipping the clutch. From a vehicle dynamics perspective both states have to be used in order to be able to distribute propelling torque to the front and the rear axle. For instance in a tight curve at low speed, the system has to drive primarily the front axle and the torque transferred to the rear axle is enabled by means of a controlled torque capacity over the rear clutch, which is slipping. On the other hand, at cornering beyond a certain speed, the rear axle has to be driven primarily in order to ensure freely distributed propelling torques.

The inventor has realized that the vehicle dynamic's state at these elevated velocities results in a nominal different velocity between the front and rear differentials, which is higher at the rear than in the front, i.e. it has an opposite sign at low speed cornering.

Embodiments of the present invention hence relate to a control method that, with help from signals from existing vehicle systems, such as other electronic control units (ECU's) like Anti-Locking Braking System (ABS), Electronic Stability Program (ESP), and engine management, determines the vehicle state and the most adequate control mode of the double coupling device.

According to one embodiment of the invention, the nominal velocity difference between both differentials is computed by using signals from the ABS/ESP unit and engine management with a reference model in the electronic control unit of the double coupling device. The Electronic Control Unit of the double coupling device may according to some embodiments be located physically on the double coupling device, or according to other embodiments the method may be implemented in software run on hardware of existing electronic control units, e.g. the Electronic Control Unit of the ABS/ESP.

The nominal velocity difference is used as a base signal to determine the control state of the double coupling device or equivalent torque distribution devices as mentioned above. Two base control states can be distinguished, primarily Front Wheel Drive (FWD) and primarily Rear Wheel Drive (RWD). Primarily FWD implies a synchronous state of the gearbox output and the front differential. A primarily Rear Wheel Drive (RWD) state implies a synchronous state of the gearbox output and the rear differential. Of course, a state transition may only-take place when the actual difference velocity allows this in respect to Noise, Vibrations and Harshness (NVH) issues That is, the actual difference velocity shall be low.

With reference to FIG. 1, the free rolling nominal velocity difference between the axles is defined as:

$$Δ V = {V}_{{F}_{x}}^{W} - {V}_{{R}_{x}}^{W} = [ cos δ - 1 sin δ α sin δ ] [ \begin{matrix}u \\ v \\ r\end{matrix} ]$$

wherein

ΔV Velocity difference between axle differentials

V_{F}_{ₓ}^{W} Longitudinal velocity of front axle (velocity of front differential)

V_{R}_{ₓ}^{W} Longitudinal velocity of rear axle (velocity of rear differential)

Other variables see below under nomenclature.

In the above formula (I) the longitudinal, lateral and yaw velocity are assumed known signals by means of measurement, which is done by deriving the velocity signals from existing sensors, or estimation techniques. There is no need for additional acceleration sensors dedicated for the single purpose of delivering signals for the present vehicle dynamics regulation method. The signal quality and accuracy is beyond the scope of this invention. The axle velocity difference ΔV may be transformed to angular velocity difference over the double coupling device including possibly mechanical different final gear ratios. According to one embodiment, it is the sign of velocity difference between the both outgoing shafts from the double coupling device that determines the possible control state, which may be altered by mechanical gear ratio difference of the final drives in the front and rear axle. In a specific embodiment described now, the use of this velocity difference is explained in more detail.

More precisely, an exemplary embodiment of the invention is as follows:

1. A reference model in conjunction with measured signals is used to compute a nominal velocity difference between the front and rear differential. This nominal velocity difference is one of the signals that determines the control state of the double coupling device.

2. The result of a reference model and measured signals determines the control state that always allows drive torques to all driven wheels. Drive torques are ensured as long as the slippage over the clutch that is not in a synchronous state is positive. That is, the input shaft (from gearbox) runs faster than the output shaft (to axle differentials).

3. The choice of control state avoids the (traction) control problems for Rear Wheel Drive (RWD) based “hang-on” vehicles in tight corners in the low range of the velocity envelope and thus poor off-road capabilities. In tight corners the front axle has a larger curve radius than the rear axle and thereby has to run faster than the rear axle. The nominal fastest axle shall run synchronous with the gearbox output in order to comply with the present embodiment.

4. The choice of control state avoids the power-on under-steering problems of a FWD based “hang-on” vehicle at cornering in the midrange of the velocity envelope (50-120 km/h). Beyond a certain speed the rear axle will run a larger curve radius than the front axle. Therefore the rear axle shall run synchronous at these elevated velocities to ensure drive torques at all wheels without excessive slip at one of the front wheels. This is ensured by using the above-described nominal velocity difference as an input parameter for controlling the state of the double coupling.

Applications and use of the above described method and system for regulating the driving dynamics of a vehicle according to the invention are various and include exemplary fields such as four wheel driven (4WD) cars and trucks.

The invention may be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed, the functionality may be implemented in a single unit, in a plurality of units or as part of other functional units. As such, the invention may be implemented in a single unit, or may be physically and functionally distributed between different units and processors.

Although the present invention has been described above with reference to a specific embodiment, it is not intended to be limited to the specific form set forth herein. Rather, the invention is limited only by the accompanying claims, and other embodiments than the specific one above are equally possible within the scope of these appended claims, e.g. different coupling devices than those described above.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

### NOMENCLATURE

a Distance from front axle to cog
b Distance from rear axle to cog
l Wheelbase
r Yaw velocity
r As index: circumferential
s As index: slip
t Track width
u Longitudinal velocity
v Lateral velocity
x As index: longitudinal
y As index: lateral
F Front
R Rear
P Pole of vehicle velocity (curve centre)
V Velocity vector
W Wheel coordinate system
α Slip angle
β Vehicle slip angle
δ Steer angle

1. A method of regulating the driving dynamics of a vehicle by controlling a torque distribution in a drive system from a vehicle engine between at least two axles of the vehicle, comprising
controlling said torque distribution and a control state of the system with a nominal velocity difference between the different axles as an input value.

2. The method according to claim 1, wherein the vehicle has two axles, each axle having two hubs at opposite sides thereof and a differential in-between, respectively, wherein the nominal velocity difference is a nominal velocity difference between the front and rear differentials.

3. The method according to claim 1, comprising
calculating said nominal velocity difference between axle differentials by using signals from an ABS/ESP unit of the vehicle and engine management with a reference model in an electronic control unit of a double coupling device distributing the torque.

4. The method according to claim 3, wherein said calculating and controlling being performed in an Electronic Control Unit of the double coupling device.

5. The method according to claim 4, wherein said calculating and controlling being performed in an already existing Electronic Control Unit of the vehicle.

6. The method according to claim 1, wherein the nominal velocity difference is used as a base signal to determine the control state of a torque distribution device controlling the torque distribution from the vehicle engine between said at least two axles of the vehicle.

7. The method according to claim 6 for a vehicle with a front axle and a rear axle, wherein said control state comprises two base control states being a primarily Front Wheel Drive (FWD) control state comprising a synchronous state of a gearbox output from the engine and a front differential at the front axle, and a primarily Rear Wheel Drive (RWD) control state comprising a synchronous state of a gearbox output from the engine and a rear differential at the rear axle.

8. The method according to claim 7, comprising using a reference model of the vehicle in conjunction with measured signals to compute the nominal velocity difference between a front and rear differential for determining said control state of the torque distribution device, wherein the result of the reference model and measured signals determines a control state that always allows drive torques to all driven wheels.

9. The method according to claim 7, comprising
locking the nominally fastest axle to run at a synchronous state with the output of the gearbox of the vehicle, such that traction control problems are avoided.

10. The method according to claim 1, wherein said nominal velocity difference is a free rolling nominal velocity difference between two axles of a four wheel driven vehicle defined as:
$$Δ V = {V}_{{F}_{x}}^{W} - {V}_{{R}_{x}}^{W} = [ cos δ - 1 sin δ α sin δ ] [ \begin{matrix}u \\ v \\ r\end{matrix} ] ;$$
wherein
ΔV is a velocity difference between a front and rear axle differential,
V_{F}_{ₓ}^{W} is a longitudinal velocity of the front axle or velocity of a front differential,
V_{R}_{ₓ}^{W} is a longitudinal velocity of rear axle or velocity of a rear differential, u Longitudinal velocity
u is a longitudinal velocity of the vehicle,
v is a lateral velocity of the vehicle,
r is a yaw velocity of the vehicle,
α is a slip angle, and
δ is a steer angle of the vehicle.

11. The method according to claim 10, wherein said input parameters for calculating said velocity difference are derived from signals delivered by existing components of the vehicle or estimation techniques.

12. A system for regulating the driving dynamics of a vehicle, said system being adapted to control a torque distribution in a drive system from a vehicle engine between at least two axles of the vehicle, said system comprising
means for controlling said torque distribution and a control state of the system with a nominal velocity difference between the different axles as an input value.

13. A computer-readable medium having embodied thereon a computer program for regulating the driving dynamics of a vehicle for processing by a computer, wherein the computer program is configured to control a torque distribution in a drive system from a vehicle engine between at least two axles of the vehicle, wherein the computer program comprises
a code segment for controlling said torque distribution and a control state of the system with a nominal velocity difference between the different axles as an input value.

14. An input signal for regulating the driving dynamics of a vehicle in a system being adapted to control a torque distribution and a control state from a vehicle engine between at least two axles of the vehicle, said signal comprising information for controlling said torque distribution and said control state derived from a nominal velocity difference between the different axles, wherein said signal is an input value used for regulating the driving dynamics of the vehicle.

15. The method according to claim 2, comprising
calculating said nominal velocity difference between axle differentials by using signals from an ABS/ESP unit of the vehicle and engine management with a reference model in an electronic control unit of a double coupling device distributing the torque.

16. The method according to claim 8, comprising
locking the nominally fastest axle to run at a synchronous state with the output of the gearbox of the vehicle, such that traction control problems are avoided.
